(19) United States
(12) Patent Application Publication
(10) Pub. No.: US 2019/0308048 A1
(43) Pub. Date: Oct. 10, 2019

(54) FIRE PROTECTION SYSTEM FOR AN ELECTRICAL APPLIANCE

(71) Applicant: Thomas O'Hara, SeaBrook, NH (US)

(72) Inventor: Thomas O'Hara, SeaBrook, NH (US)

(21) Appl. No.: 16/296,137

(22) Filed: Mar. 7, 2019

Related U.S. Application Data
(60) Provisional application No. 62/655,710, filed on Apr. 10, 2018.

(51) Int. Cl. A62C 37/40; A62C 2/06; D06F 58/28

(52) U.S. Cl. CPC A62C 37/40; D06F 2058/2858; D06F 58/28; A62C 3/14

(57) ABSTRACT

Disclosed herein is a fire protection system for an electrical appliance, in accordance with some embodiments. Further, the fire protection system may include a vent door disposed on a front surface of the electrical appliance. Further, the vent door may be configured to provide direct access to an opening of a vent of the electrical appliance. Further, the fire protection system may include a heat sensor thermally coupled to the vent. Further, the heat sensor may be configured to detect a temperature of the vent. Further, the fire protection system may include at least one fire extinguisher configured to dispense a fire retardant within the vent. Further, the fire protection system may include an actuator electrically coupled to each of the heat sensor and the at least one fire extinguisher. Further, the actuator may be configured to activate the at least one fire extinguisher based on the temperature.

### RELATED APPLICATION(S)

Under provisions of 35 U.S.C. § 119e, the Applicant(s) claim the benefit of U.S. provisional application no. 62655710, titled “Fire protection system for a clothes dryer”, filed on Apr. 10, 2018 which is incorporated herein by reference.

### TECHNICAL FIELD

Generally, the present disclosure relates to the field of appliance safety systems. More specifically, the present disclosure relates to a fire protection system for an electrical appliance.

### BACKGROUND

Millions of households accumulate lint in the vent leading away from their clothes dryers. Over a period of years, a large accumulation of lint in the vent can trap the heat that is normally vented, creating a fire hazard. Cleaning out the vent is a chore that most homeowners aren't even aware of, and for those who are aware that it must be done, it is a difficult and tiresome task. If the clothes dryer provided features which enabled easy cleaning of the vent, as well as a fire extinguishing system in the event that a fire does occur, such an appliance would be very useful, and would be well received. A fire protection system for a clothes dryer, which provides a fire extinguishing feature and easy access to the vent for cleaning purposes, would resolve this problem.

Therefore, there is a need for an improved fire protection system for an electrical appliance that may overcome one or more of the above-mentioned problems and/or limitations.

### SUMMARY

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a fire protection system for an electrical appliance, in accordance with a first exemplary embodiment. Further, the fire protection system may include a vent door disposed on a front surface of the electrical appliance. Further, the vent door may be below a main door of the electrical appliance. Further, the vent door may be configured to provide direct access to an opening of a vent of the electrical appliance in order to facilitate cleaning of the vent. Further, the fire protection system may include a heat sensor thermally coupled to the vent. Further, the heat sensor may be configured to detect a temperature of the vent. Further, the fire protection system may include at least one fire extinguisher configured to dispense a fire retardant within the vent. Further, the fire protection system may include an actuator electrically coupled to each of the heat sensor and the at least one fire extinguisher. Further, the actuator may be configured to activate the at least one fire extinguisher based on the temperature.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 shows a fire protection system for an electrical appliance, in accordance with a first exemplary embodiment.

FIG. 3 is a front transparency view of the electrical appliance of FIG. 2.

FIG. 4 is a side view of the electrical appliance of FIG. 2.

FIG. 5 is a side transparency view of the electrical appliance of FIG. 2.

FIG. 6 is a side view of the fire protection system of FIG. 2 without the electrical appliance.

FIG. 7 is a close-up perspective view of a vent door the fire protection system of FIG. 2.

FIG. 8 is a block diagram of a computing device for implementing the methods disclosed herein, in accordance with some embodiments.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of a fire protection system for an electrical appliance, embodiments of the present disclosure are not limited to use only in this context.

### Overview

According to some embodiments, the present disclosure is directed to a fire protection system for an electrical appliance (such as a clothes dryer). The fire protection system provides a small door on a front surface of the clothes dryer, below the main door, which provides direct access to the vent for cleaning purposes. The fire protection system further provides a heat sensor and a pair of fore-and-aft extinguishers which, when activated, may spray fire retardant chemicals throughout the length of the vent. The heat sensor may automatically activate the extinguishers if the vent temperature exceeds a predetermined safe range. A manual override button for the extinguishers may also be provided on the front surface of the clothes dryer.

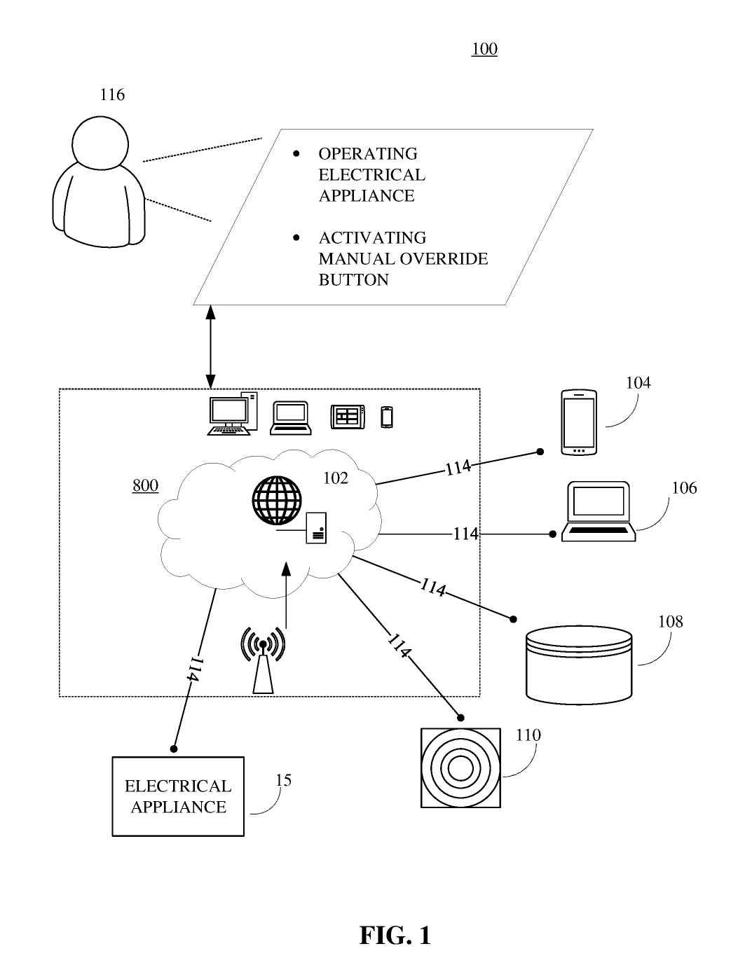

Referring now to figures, FIG. 1 is an illustration of an online platform 100 consistent with various embodiments of the present disclosure. By way of non-limiting example, the online platform 100 to facilitate fire protection system for an electrical appliance may be hosted on a centralized server 102, such as, for example, a cloud computing service. The centralized server 102 may communicate with other network entities, such as, for example, a mobile device 104 (such as a smartphone, a laptop, a tablet computer etc.), other electronic devices 106 (such as desktop computers, server computers etc.), databases 108, sensors 110 and electrical appliance 15, over a communication network 114, such as, but not limited to, the Internet. Further, users of the online platform 100 may include relevant parties such as, but not limited to, end users, administrators, service providers, service consumers and so on. Accordingly, in some instances, electronic devices operated by the one or more relevant parties may be in communication with the platform.

A user 116, such as the one or more relevant parties, may access online platform 100 through a web based software application or browser. The web based software application may be embodied as, for example, but not be limited to, a website, a web application, a desktop application, and a mobile application compatible with a computing device 800.

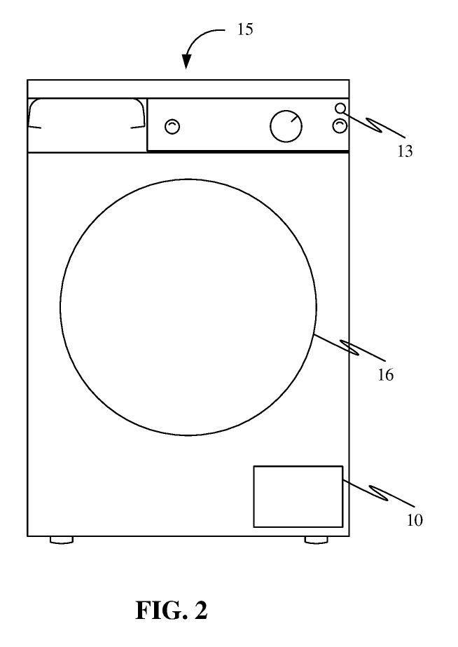

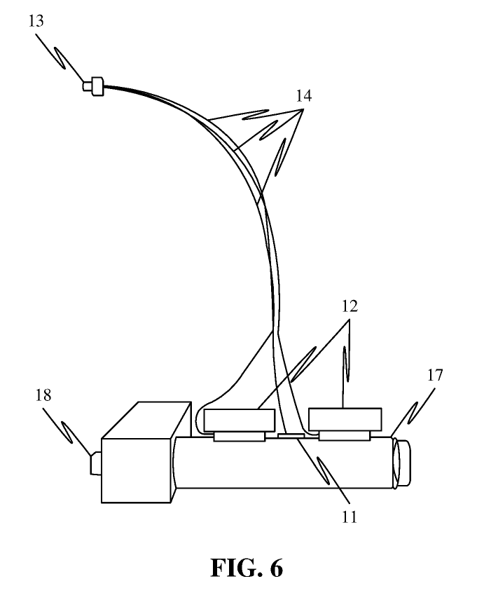

FIG. 2 shows a fire protection system for an electrical appliance 15, in accordance with a first exemplary embodiment. As shown, the electrical appliance 15 may be a clothes dryer. The fire protection system is explained in further detail in conjunction with FIG. 6 below.

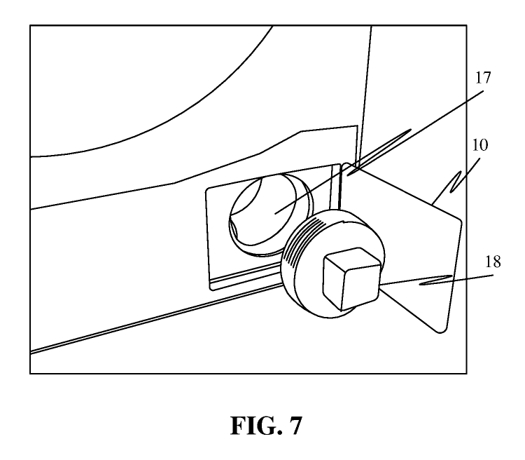

Further, the fire protection system may include a vent door 10 disposed on a front surface of the electrical appliance 15. Further, the vent door 10 may be below a main door 16 of the electrical appliance 15. Further, as shown in FIG. 7, the vent door 10 may be configured to provide direct access to an opening of a vent 17 of the electrical appliance 15 in order to facilitate cleaning of the vent 17. Further, in some embodiments, the opening of the vent 17 may be configured to mechanically couple with a wand attachment of a vacuum cleaner.

Further, the fire protection system may include a heat sensor 11 (as shown in FIG. 6) thermally coupled to the vent 17. Further, the heat sensor 11 may be configured to detect a temperature of the vent 17.

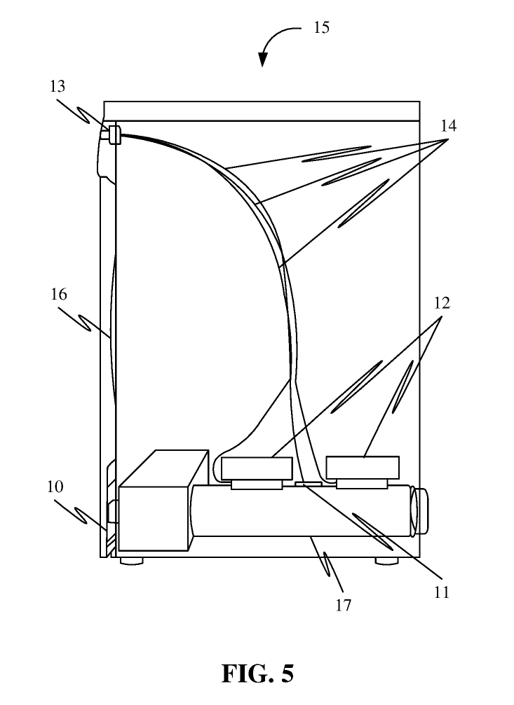

Further, the fire protection system may include at least one fire extinguisher configured to dispense a fire retardant within the vent 17. Further, in some embodiments, the at least one fire extinguisher may include a pair of fore-and-aft extinguishers 12 (as shown in FIG. 5) configured to dispense the fire retardant throughout a length of the vent 17. Further, the heat sensor 11 may be mounted on the vent 17 in between the pair of fore-and-aft extinguishers 12. Further, in some embodiments, the at least one fire extinguisher may be configured to spray fire retardant chemicals.

Further, the fire protection system may include an actuator (not shown) electrically coupled to each of the heat sensor 11 and the at least one fire extinguisher. Further, the actuator may be configured to activate the at least one fire extinguisher based on the temperature. Further, in some embodiments, the actuator may be configured to automatically activate the at least one fire extinguisher when the temperature of the vent 17 exceeds a predetermined safe value.

Further, in some embodiments, the fire protection system may include a manual override button 13 coupled to the actuator. Further, the manual override button 13 may be disposed on the front surface of the electrical appliance 15. Further, the manual override button 13 may be configured to perform at least one of activation and deactivation of the at least one fire extinguisher.

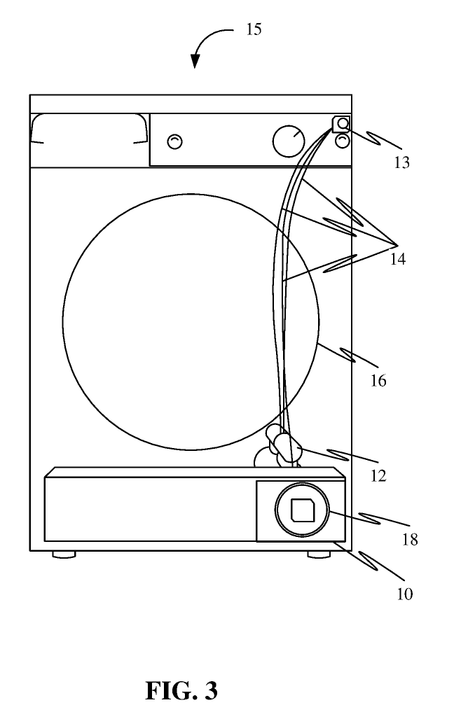

Further, in some embodiments, the fire protection system may include an endcap 18 (as shown in FIG. 3) configured to detachably cover the opening of the vent 17. Further, the endcap 18 may be configured to be concealed behind the vent door 10. Further, in some embodiments, each of the vent door 10, the heat sensor 11, the actuator, the endcap 18 may include a heat resistant material.

Further, the fire protection system includes the vent door 10 on the front surface of the electrical appliance 15, below the main door 16, providing access to the vent 17 via a threaded endcap (such as the endcap 18) concealed behind the vent door 10. By opening the vent door 10 and removing the endcap 18, the user may periodically clean out the vent 17 with a vacuum sweeper and wand attachment. This prevents the accumulation of lint in the vent 17, which presents a fire hazard.

The fire protection system may further include two fore-and-aft extinguishers 12 mounted on top of the vent 17, and a heat sensor 11 mounted on the vent 17 between the two fore-and-aft extinguishers 12. If the temperature in the vent 17 exceeds a predetermined safe operating range, the two fore-and-aft extinguishers 12 are activated, spraying fire retardant chemicals into the vent 17. Further, the fire protection system may include a manual override button 13. For example, the manual override button 13 may be provided on the front surface of the electrical appliance 15, above the main door 16. When pressed, the manual override button 13 activates the two fore-and-aft extinguishers 12. The two fore-and-aft extinguishers 12, the heat sensor 11, and the manual override button 13 are connected by wires 14; these components may be preferably powered by the main electric supply to the electrical appliance 15.

To use the first exemplary embodiment, the user may periodically open the vent door 10, remove the endcap 18, and clean out the vent 17, using a vacuum sweeper with a wand attachment or a similar device. Under normal circumstances, operation of the two fore-and-aft extinguishers 12 may be automatic. If the user detects a fire in the vent 17 and the two fore-and-aft extinguishers 12 have not been activated, the user may press the manual override button 13 to activate the two fore-and-aft extinguishers 12.

The vent door 10, the endcap 18, the heat sensor 11, the two fore-and-aft extinguishers 12, and the manual override button 13 may be preferably manufactured from rigid, durable materials which may be heat resistant, such as (but not limited to) steel, plastic, ceramics, and aluminum alloy. The wires 14 may be preferably manufactured from braided copper alloy sheathed in plastic. Components, component sizes, and materials listed above are preferable, but artisans may recognize that alternate components and materials could be selected without altering the scope of the invention.

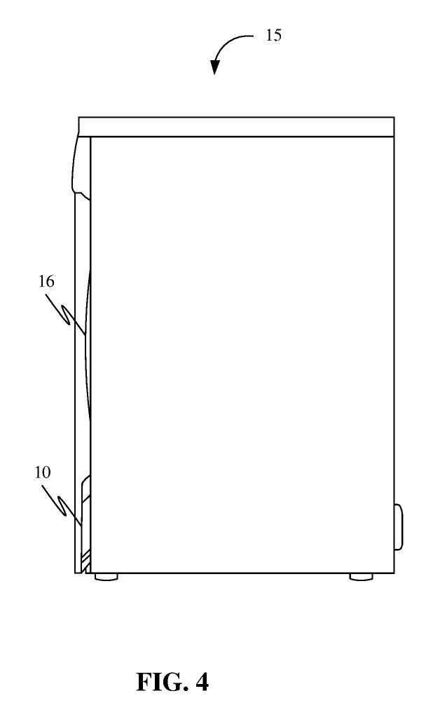

Further, FIG. 3 is a front transparency view of the electrical appliance 15 with the first exemplary embodiment, displaying the vent door 10, the two fore-and-aft extinguishers 12, the manual override button 13, the wires 14, the electrical appliance 15, and the main door 16. Further, FIG. 4 is a side view of the electrical appliance 15 with the first exemplary embodiment, displaying the vent door 10, the electrical appliance 15, and the main door 16.

Further, FIG. 5 is a side transparency view of the electrical appliance 15 with the first exemplary embodiment, displaying the vent door 10, the heat sensor 11, the two fore-and-aft extinguishers 12, the manual override button 13, the wires 14, the main door 16, and the vent 17. Further, FIG. 6 is a side view of the first exemplary embodiment, displaying the endcap 18, the heat sensor 11, the two fore-and-aft extinguishers 12, the manual override button 13, the wires 14, and the vent 17.

Further, FIG. 7 is a front perspective view of a vent door area of the first exemplary embodiment, displaying the vent door 10, the endcap 18, and the vent 17.

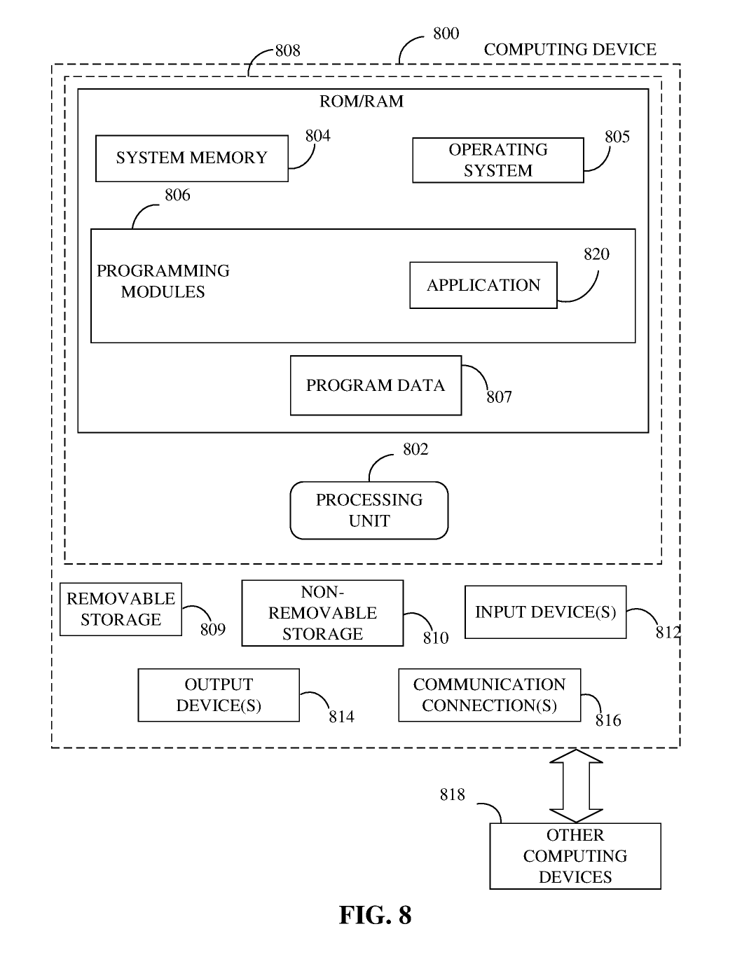

With reference to FIG. 8, a system consistent with an embodiment of the disclosure may include a computing device or cloud service, such as computing device 800. In a basic configuration, computing device 800 may include at least one processing unit 802 and a system memory 804. Depending on the configuration and type of computing device, system memory 804 may comprise, but is not limited to, volatile (e.g. random-access memory (RAM)), non-volatile (e.g. read-only memory (ROM)), flash memory, or any combination. System memory 804 may include operating system 805, one or more programming modules 806, and may include a program data 807. Operating system 805, for example, may be suitable for controlling computing device 800's operation. In one embodiment, programming modules 806 may include image-processing module, machine learning module. Furthermore, embodiments of the disclosure may be practiced in conjunction with a graphics library, other operating systems, or any other application program and is not limited to any particular application or system. This basic configuration is illustrated in FIG. 8 by those components within a dashed line 808.

Computing device 800 may have additional features or functionality. For example, computing device 800 may also include additional data storage devices (removable and/or non-removable) such as, for example, magnetic disks, optical disks, or tape. Such additional storage is illustrated in FIG. 8 by a removable storage 809 and a non-removable storage 810. Computer storage media may include volatile and non-volatile, removable and non-removable media implemented in any method or technology for storage of information, such as computer-readable instructions, data structures, program modules, or other data. System memory 804, removable storage 809, and non-removable storage 810 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 800. Any such computer storage media may be part of device 800. Computing device 800 may also have input device(s) 812 such as a keyboard, a mouse, a pen, a sound input device, a touch input device, a location sensor, a camera, a biometric sensor, etc. Output device(s) 814 such as a display, speakers, a printer, etc. may also be included. The aforementioned devices are examples and others may be used.

Computing device 800 may also contain a communication connection 816 that may allow device 800 to communicate with other computing devices 818, such as over a network in a distributed computing environment, for example, an intranet or the Internet. Communication connection 816 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 804, including operating system 805. While executing on processing unit 802, programming modules 806 (e.g., application 820 such as a media player) may perform processes including, for example, one or more stages of methods, algorithms, systems, applications, servers, databases as described above. The aforementioned process is an example, and processing unit 802 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

We claim:

1. A fire protection system for an electrical appliance, wherein the fire protection system comprises:
a vent door disposed on a front surface of the electrical appliance, wherein the vent door is below a main door of the electrical appliance, wherein the vent door is configured to provide direct access to an opening of a vent of the electrical appliance in order to facilitate cleaning of the vent;
a heat sensor thermally coupled to the vent, wherein the heat sensor is configured to detect a temperature of the vent;
at least one fire extinguisher configured to dispense a fire retardant within the vent; and
an actuator electrically coupled to each of the heat sensor and the at least one fire extinguisher, wherein the actuator is configured to activate the at least one fire extinguisher based on the temperature.

2. The fire protection system of claim 1, wherein the at least one fire extinguisher comprises a pair of fore-and-aft extinguishers configured to dispense the fire retardant throughout a length of the vent.

3. The fire protection system of claim 2, wherein the heat sensor is mounted on the vent in between the pair of fore-and-aft extinguishers.

4. The fire protection system of claim 1, wherein the at least one fire extinguisher is configured to spray fire retardant chemicals.

5. The fire protection system of claim 1, wherein the actuator is configured to automatically activate the at least one fire extinguisher when the temperature of the vent exceeds a predetermined safe value.

6. The fire protection system of claim 1 further comprising a manual override button coupled to the actuator, wherein the manual override button is disposed on the front surface of the electrical appliance, wherein the manual override button is configured to perform at least one of activation and deactivation of the at least one fire extinguisher.

7. The fire protection system of claim 1 further comprising an endcap configured to detachably cover the opening of the vent, wherein the endcap is further configured to be concealed behind the vent door.

8. The fire protection system of claim 7, wherein each of the vent door, the heat sensor, the actuator, the endcap comprises a heat resistant material.

9. The fire protection system of claim 1, wherein the opening is configured to mechanically couple with a wand attachment of a vacuum cleaner.

10. The fire protection system of claim 1, wherein the electrical appliance is a clothes dryer.
